(19) United States
(12) Patent Application Publication
(10) Pub. No.: US 2020/0362605 A1
(43) Pub. Date: Nov. 19, 2020

(54) COVER LOCKING MECHANISM

(71) Applicant: FNSS SAVUNMA SISTEMLERI ANONIM SIRKETI, Gölbasi, ANKARA (TR)

(72) Inventors: Gürkan ALARCIN, Gölbasi, ANKARA (TR); Çagri-Kaya ÖZCAN, Gölbasi, ANKARA (TR); Mesut YAGMUR, Gölbasi, ANKARA (TR)

(73) Assignee: FNSS SAVUNMA SISTEMLERI ANONIM SIRKETI, Gölbasi, ANKARA (TR)

(21) Appl. No.: 16/638,996

(22) PCT Filed: Dec. 31, 2018
(86) PCT No.: PCT/TR2018/050950

§ 371 Date: Feb. 13, 2020

(30) Foreign Application Priority Data
Feb. 7, 2018 (TR) 2018/01745

(51) Int. Cl. E05B 83/00; E05B 63/00; E05C 3/04; E05B 77/34

(52) U.S. Cl. CPC E05B 83/01; E05B 63/006; E05Y 2900/504; E05B 77/34; E05C 3/042

(57) ABSTRACT

The invention is related to a locking mechanism (A) which enables the attachment of the covers (B) on military vehicles having different thicknesses to the body (C) of the vehicles. The invention is characterized in comprising a locking pin (10) having a partial or complete screw structure; a lock bolt (70) which is coupled to the locking pin (10) and whose tightening distance is determined depending on the length of the locking pin (10) screw length thereon, which transfers the motion at the rotation direction (W) of said locking pin (10) as a vertical motion and which locks the cover (B) to the body (C) and then releases said cover (B) by means of the rotation motion received from the locking pin (10), a lock body (40) which forms a border to the lock bolt (70) and allows the required tightening force to be applied to the locking pin (10), which limits the motion of the stop surface (41) and the lock bolt (70) at the rotation axis (W), having the opposite stop surface (42) thereon and on which all of the components of the locking mechanism (A) is positioned, and a pressure spring (50) which is positioned on the locking pin (10) and creates pressure between the locking pin (10) and he lock bolt (70) and allows that lock bolt (70) to rotate at the same time when the locking pin (10) is rotated.

### CROSS-REFERENCE TO RELATED APPLICATIONS

This application claims priority under 35 U.S.C. § 371 to the International Application No. PCT/TR2018/050950, filed Dec. 31, 2018, and to the Turkish Application No. 2018/01745, filed Feb. 7, 2018, now pending, the contents of which are hereby incorporated by reference.

### TECHNICAL FIELD

The invention is related to a cover locking mechanism which can lock the covers found on military vehicles having different thicknesses onto the body of the vehicle with a rotation motion at a 90° angle without the need to use additional connection elements in order to provide impermeability.

### KNOWN STATE OF THE ART (PRIOR ART)

Nowadays several military vehicle designs and products are being conducted to be used as assault and defense vehicles and to carry personnel in the defense industry. When these vehicles are being designed, one of the most important issues that needs to be taken into consideration is for the personnel to be able to carry out rapid and easy action in cases of combat or emergency situations. Especially, if any kind of breakdown is faced regarding the components operating on the vehicle, it is important to be able to step in quickly. The maintenance or safeguarding covers need to be easily assembled and disassembled in order to be able to reach the related section in order to carry out rapid interventions. It is not suitable to use hinge typed cover connections as the inner area of the vehicle has limited space in cases that the interventions are carried out from inside the vehicle. It is also important for all covers inside the vehicle or outside the vehicle to be opened and closed to use the same types of equipment. The coupling methods of the covers located outside the vehicle also need to have a structure that can provide impermeability against effects that may be received from the external environment.

As the locking body is fixed by means of a mounting nut onto the cover in quarter turn mechanisms that are used in the present art, the thickness of the cover directly affects the mounting process. The differences of the thicknesses of the maintenance covers provided on military vehicles may vary significantly. Due to this reason, the present standardized locking mechanism with quarter turn cannot be used for all covers and this necessitates the usage of locking mechanisms with different sizes to be used for different cover thicknesses. Again in the present locking mechanisms, as the cover clenching distance depends on the shape of the lock bolt, the length of the locking pin and therefore the size of the lock body, it is inevitable to use locking mechanisms that have different lock bolts, pin lengths and lock bodies for covers with different thicknesses.

The spring element that is used in the locking mechanisms of the prior art, determines the pressing force of the cover and the tightening force that is necessary to open or close the lock. This spring works well in short distances and it provides sufficient efficiency in covers having fixed thicknesses. However, In covers where high pressing force and sealing is required, stiffer springs that may apply higher pressure forces need to be used instead of standard springs. In such a case higher force is required in order to open or close the cover. When covers having different tightening forces are available on vehicles, as a standard type spring usage is not suitable, locks having different spring types need to be used.

When locking mechanisms having low spring pressure forces are used as there is insufficient pressing force applied on the cover, it is impossible to provide sealing of the cover. When the usage areas and the conditions of the military vehicles are taken into consideration it is a must for the maintenance covers to provide impermeability. The lock mechanisms having low pressing forces may open on its own due to oscillation in military vehicles that operate on rough terrain and these mechanisms cannot provide the required sealing conditions.

As a result of the research carried out regarding the present technique, the patent numbered 2013/03224 and titled “A lock for fixing a feeding box to a vehicle and a method for attaching the feed box to the vehicle having such a configuration has been found. The invention is formed basically of a lock bolt that is fixed to the body of the vehicle by being mounted such that it is rotatable inside the body section and a pressure element that has been mounted on the bottom leg such that it protrudes relative to the bottom section of the body. Although the invention is similar to the quarter turn locking mechanism mentioned above in terms of structure, it provides suitable locking of components such as batteries to the body of the vehicle. However, it is not suitable to be used on components such as covers having different thicknesses, and it is insufficient to provide variable tightening force, tightening distance and impermeability. Due to the reasons mentioned above, the described invention of the prior art does not eliminate the present disadvantages.

As a result, due to the disadvantages mentioned above, because of the present solutions are inadequate the development in the related field has been seen to be a necessity.

### AIM OF THE INVENTION

The invention has been formed by being inspired from present situations and it aims to solve the disadvantages mentioned above.

The main aim of the invention is to provide a locking mechanism which enables opening and closing of covers on military vehicles having different thicknesses without using any additional equipment.

Another aim of the invention is to ensure the attachment of covers having different thicknesses onto the vehicle bodies also having different thicknesses by applying an adjustable tightening force.

Another aim of the invention is to prevent the lock bolt from falling down on its own even under low tightening force and to provide safe locking even under oscillating and shaky environments.

A locking mechanism that has been developed in order to provide all of the aims mentioned above and that may arise from the detailed description below, which enables to attach covers having different thicknesses onto the body of vehicles, characterized in comprising;
it comprises a locking pin that has a partial or complete screw structure,
a lock bolt which is coupled to the locking pin and whose tightening distance is determined depending on the length of the locking pin screw length, which transfers the motion at the rotation direction of said locking pin as a vertical motion and which locks the cover to the body and then releases it by means of the rotation motion received from the locking pin,
a lock body which forms a border to the lock bolt and allows the required tightening force to be applied to the locking pin, which limits the motion of the stop surface and the lock bolt at the rotation axis, having the opposite stop surface thereon and on which all of the components of the locking mechanism is positioned,
and a pressure spring which is positioned on the locking pin and creates pressure between the locking pin and the lock bolt and allows the lock bolt to rotate at the same time when the locking pin is rotated.

The structural and characteristic features of the invention and its advantages can be clearly understood by means of the figures and the detailed description which references the below mentioned figures and therefore if an evaluation regarding the invention is to be carried out, it is advised for said evaluation to be carried out by taking into consideration the figures and the below mentioned detailed description.

### THE FIGURES ILLUSTRATING THE INVENTION

FIG. 1, is the dismantled view of the locking mechanism subject to the invention.

FIG. 2, is the mounted view of the locking mechanism subject to the invention.

FIG. 3, is the mounted section view of the locking mechanism subject to the invention.

FIG. 4, is the view of the locking mechanism subject to the invention that is dismounted from the cover.

FIG. 5, is the view of the locking mechanism subject to the invention that is mounted onto the cover.

FIG. 6, is the section view of the locking mechanism subject to the invention that is mounted over the cover.

FIG. 7, is the perspective view of the locking mechanism subject to the invention located on the cover.

The drawings do not necessarily have to be drawn to scale and some details that are not necessary in understanding the invention may have been omitted. Besides this, the components that are significantly similar or have the similar functions have been shown with the same reference number.

### DESCRIPTION OF THE PART REFERENCES

A. Locking mechanism
   10. Locking pin
   20. Washer
   30. Gasket
   40. Lock body
      41. Stop surface
      42. Opposite stop surface
      43. Connection hole
   50. Tension spring
   60. Sealing element
   70. Lock bolt
   80. Thrust spring
   90. Cotter pin
B. Cover
C. Body
D. Cover seal
   11. First coupling means
   12. Second coupling means
   13. Third coupling means
W. Rotation direction

### DETAILED DESCRIPTION OF THE INVENTION

In this detailed description the preferred embodiments of the locking mechanism (A) has been described only in order to better explain the subject matter and such that it does not create any kind of limiting effect.

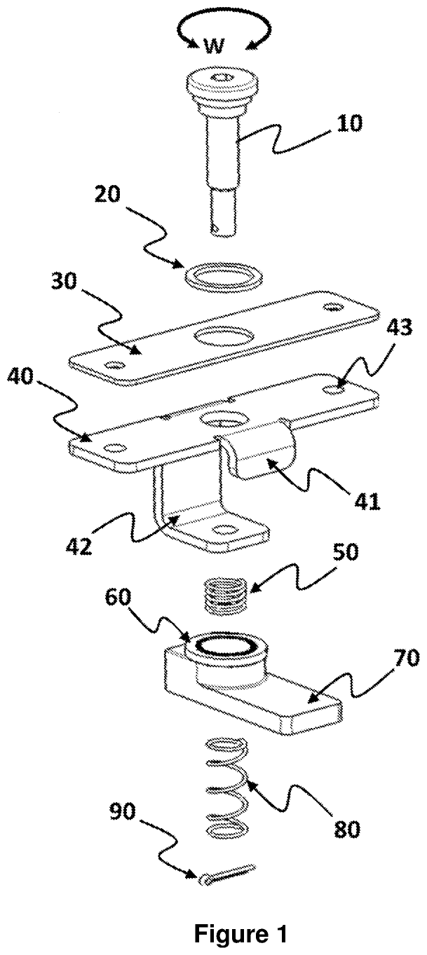

The dismounted view of the locking mechanism (A) subject to the invention has been shown in FIG. 1. Accordingly, the invention is formed basically of; a locking pin (10) which turns the lock bolt (70) in order to carry out the locking process, a lock body (40) onto which the other components of the mechanism is coupled, a tension spring (50) which ensures that the locking pin (10) and the lock bolt (70) moves together, a thrust spring (80) which enables to take up the gap by applying pressure onto the cover (B) when the lock bolt (70) is in the released position, a cotter pin (90) which fixes the mobile components forming the mechanism to the lock body (40).

The locking pin (10) which forms the rotation center of the locking mechanism (A) is mounted to the lock bolt (70) by means of the screw thread located thereon. By means of this type of screw-nut connection the locking pin (10) turns the lock bolt (70) together with itself when turned around its own axis. The motion that the locking bolt (70) carries out on the locking pin (10) is as much as the length of the screw of the locking pin (10). This screw length that is mentioned is determinative for the tightening amount of the lock bolt (7). By means of the changeable tightening distance, this allows the locking mechanism (A) to be able to be used in covers (B) that have different thicknesses.

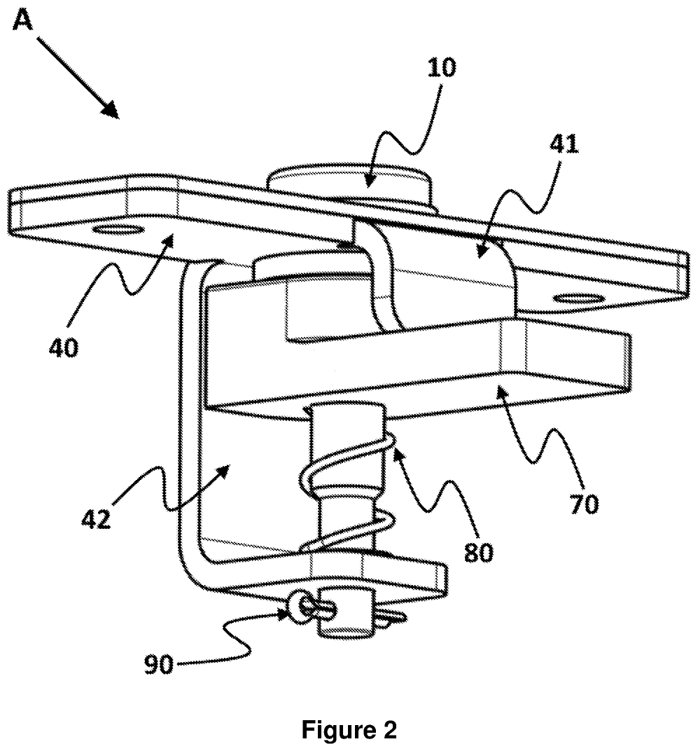

The mounted view of the locking mechanism (A) subject to the invention has been shown in FIG. 2. Accordingly, the locking pin (10) is mounted into the lock body (40) together with the washer (20) that has been coupled to the top section. This process is carried out together with the gasket (30) located on the lock body (40). The gasket (30) is used to ensure that the internal parts of the cover (B) to which the locking mechanism (A) is to be mounted are sealed against the effects from the external environment. A washer (20) is used in order to increase the pressing surface of the locking pin (10) on the gasket (30) that is located between the locking pin (10) and the lock body (40).

The lock bolt (70) is attached onto the locking pin (10) together with the tension spring (50) coupled therein. The tension spring (50) enables the pressing force to be applied onto the locking pin (50) of the lock bolt (70). By this means the locking pin (10) and the lock bolt (70) move together on the same axis. Moreover a sealing element (60) is used in order to provide impermeability between the lock body (40) and the lock bolt (70), which is mounted onto the lock bolt (70) by snap fitting. Following the completion of the mounting of the locking pin (10) and the lock bolt (70) inside the lock body (40) a thrust spring (80) is coupled. The thrust spring (80) creates a pushing force to the lock bolt (70) to which it is attached from one end. By means of this thrust force when the lock bolt (70) is not locked the space between the cover (B) and the body (C) is taken up and pre-positioning is provided.

In the final mounting step the end section of the locking pin (10), passes onto the opposite stop surface (42) of the lock body (40) having a “U” shaped profile and is coupled therein. By means of the cotter pin (90) the locking pin (10) is fixed to its final position and it is prevented from being detached. Therefore, after the mounting steps mentioned above are completed, the locking mechanism (A) is ready to carry out its locking process.

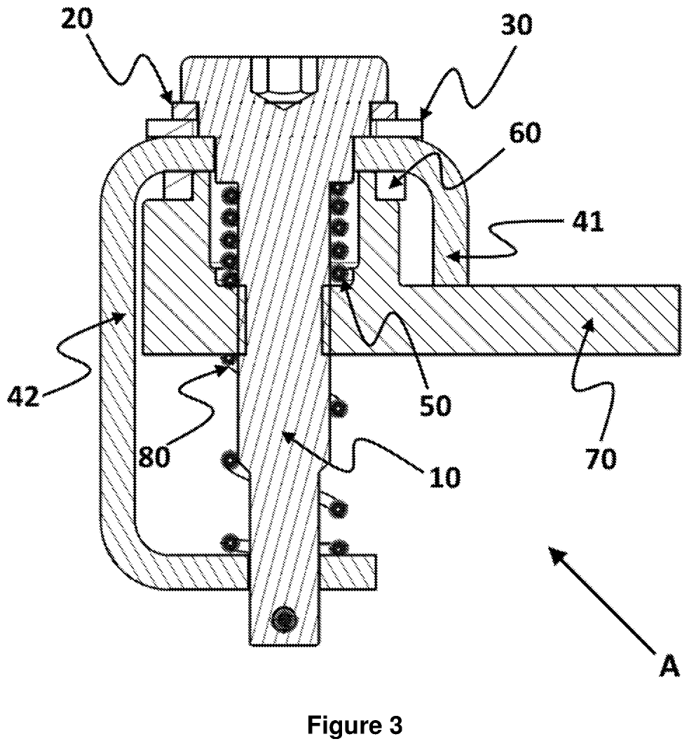

The mounted section view of the locking mechanism (A) subject to the invention has been shown in FIG. 3. Accordingly, the locking pin (10) that is positioned between the opposite stop surface (42) and the top surface of the lock body (40) is connected to the lock bolt (70). By means of the screw located on the locking pin (10) the height of the position of the lock bolt (70) can be adjusted according to the thickness of the cover (B) to which it shall be applied to. The locking pin (10) is rotated towards the right or left at a 90° angle at the rotation direction (W) and it transfers this motion to the lock bolt (70). As a result, the lock bolt (70) is either locked or released. The limiting process of limiting the axial motion of the locking pin (10) to 90° at the rotation direction (W) is carried out by the stop surface (41) and the opposite stop surface (42) located on the lock body (40).

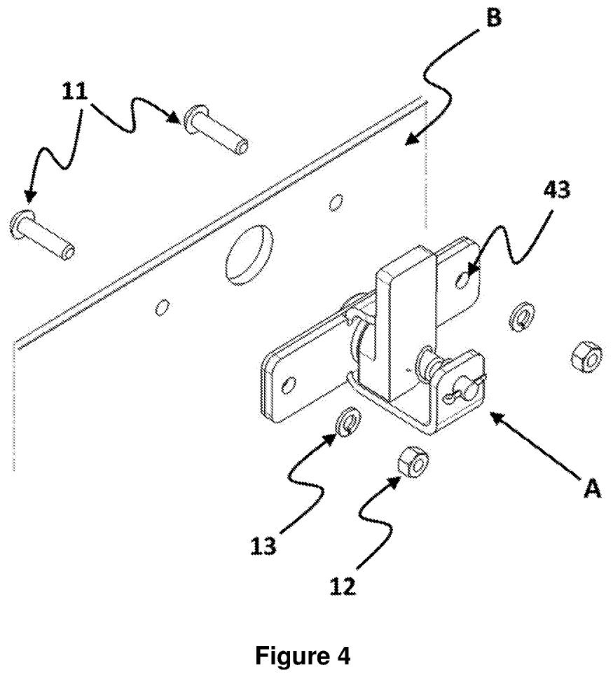

The view of the locking mechanism (A) subject to the invention, which is not mounted to the cover (B) has been shown in FIG. 4. Accordingly, the lock body (40) which is the element of the locking mechanism (A) is positioned onto the cover (B) via the first coupling means (11) through the two connection holes (43) located on the body. The first coupling means (11) which may preferably be a screw is inserted through the mounting holes found on the cover (B) and it can be tightened by means of the second coupling means (12) which may preferably be a nut and therefore the locking mechanism (A) is fixed onto the cover (B). A third coupling means (13) which is preferably a washer is used in order to prevent the unscrewing of the coupling due oscillating or shaky movement of the vehicle, wherein the coupling is created by the screw-nut connection formed by the first coupling means (11) and the second coupling means (12). A gasket (30) that is attached onto the lock body is used in order to ensure impermeability between the locking mechanism (A) and the cover (B). As a result, contaminants such as dust, water and mud are prevented from entering into the vehicle.

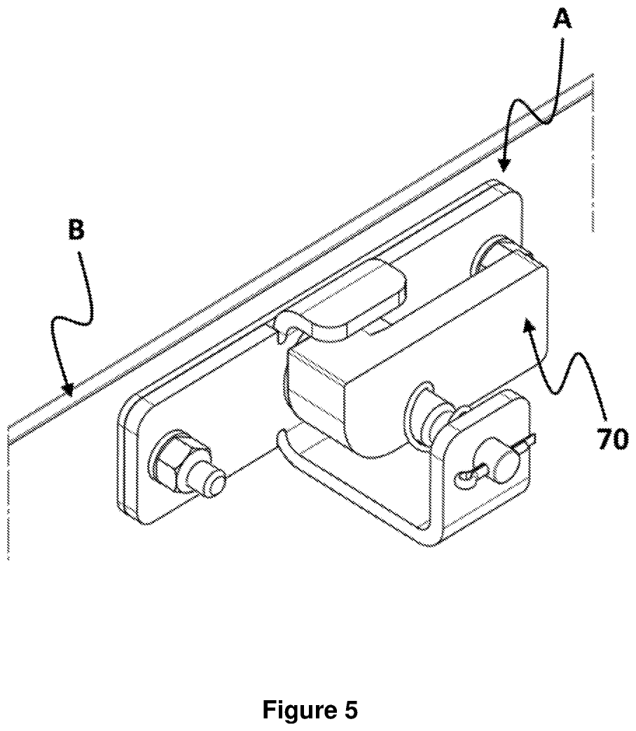

The view of the locking mechanism (A) subject to the invention which is mounted onto the cover (B) has been shown in FIG. 5. Accordingly, by turning the locking pin (10) of the locking mechanism (A) that is attached onto the cover (B) towards the rotation direction (W), the lock bolt (70) moved to the open or closed position. When the cover (B) is desired to be attached onto the body (C) the locking pin (10) is turned to the left at 90° towards the rotation direction (W) and the lock bolt (70) is moved to the open position.

The locking bolt (70) has a rectangle shape geometrically and only one corner thereof has a radius shaped design. A rotation motion that is limited to a 90° angle is obtained by means of the opposite stop surface (42) located on the lock body (40). While the corner of the lock bolt (70) having a radius shape turns without contacting the opposite stop surface (42), the vertical edge shall not turn as it shall come in contact with the opposite stop surface (42). As a result when the locking pin (10) is turned, the lock bolt (70) shall be able to be brought to the open or closed position with a 90° turn.

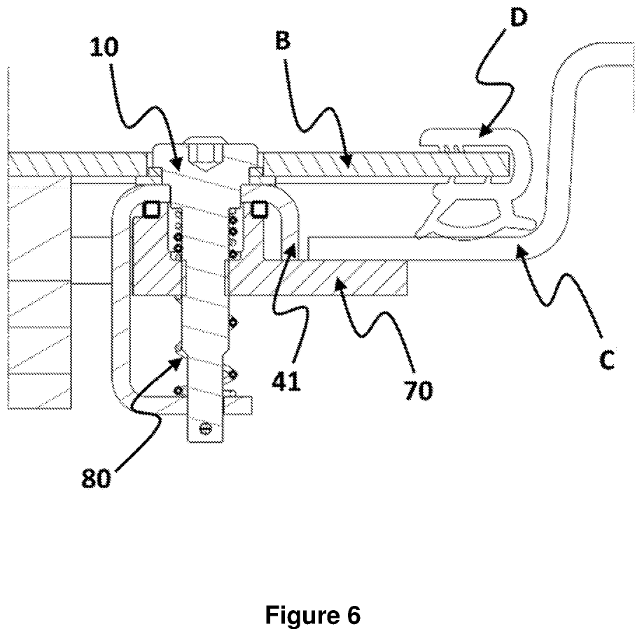

The section view of the locking mechanism (A) subject to the invention which is mounted onto the cover (B) has been shown in FIG. 6. Accordingly, when the cover (B) is desired to be attached suitably onto the body (C) the locking pin (10) is turned to the right at 90° towards the rotation direction (W) and the lock bolt (70) is moved to the locked position. By means of the thrust spring (80) which applies thrusting force to the lock bolt (70), it is enabled for the cover (B) to be fitted to the body (C) such that it is centered and secure. After the cover (B) is fitted onto the body (C) at a suitable position, the locking pin (10) is continued to be turned at the rotation direction (W) and it is enabled for the lock bolt (70) to pull the cover (B) towards the body (C) by means of the screw connection. As the lock bolt (70) is tightened by means of the locking pin (10), it is enabled for the cover (B) to be pulled towards the body (C) relative to the applied tightening force by means of the contact of the body (C) from the inner surface. After the desired cover (B) pressing force is obtained, if the locking pin (10) is continued to be tightened the locking pin (70) contacts the stop surface (41) and prevents the tightening process. As a result, the ideal force is enabled to be obtained. As a result pressure is applied onto the cover gasket (D) located between the cover (B) and the body (C) and impermeability is established against the contaminating factors or other effects that may be received from the external environment.

When the cover (B) is desired to be opened the locking pin (10) is turned again to the left towards the rotation direction (W) and the lock bolt (70) is moved to the open position and the cover (B) can be freely separated from the body (C).

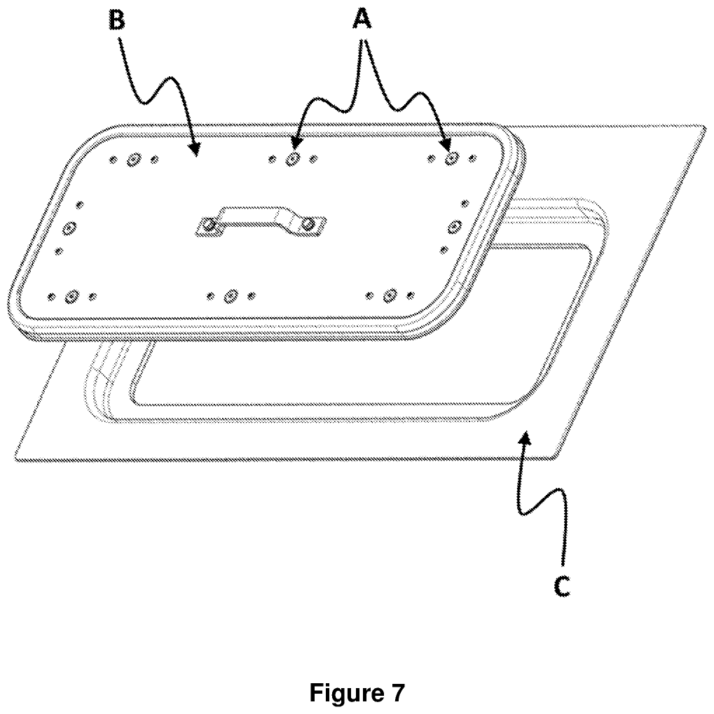

The perspective view of the locking mechanism (A) subject to the invention, on the cover (B) has been shown in FIG. 7. The usage of hinged connections on covers (B) of vehicles creates a disadvantage as the hardware that is to be maintained needs to be easily reached and as the equipment in military vehicles consume space. It is also expected for the covers (B) located on the external area of the vehicles to be impermeable against any external effects. Due to these reasons, the fitting and fixing of the covers (B) onto the body (C) is carried out by means of a locking mechanism (A). According to the limitations mentioned, any number of locking mechanisms can be attached onto the cover (B) according to situations such as the desired impermeability level and balanced pressing onto the body (C) and the size and geometry of the covers (B).

1. A locking mechanism (A) which enables the attachment of the covers (B) on military vehicles having different thicknesses to the body (C) of the vehicles characterized in comprising;
a locking pin (10) that has a partial or complete screw structure
a lock bolt (70) which is coupled to the locking pin (10) and whose tightening distance is determined depending on the length of the locking pin (10) screw length thereon, which transfers the motion at the rotation direction (W) of said locking pin (10) as a vertical motion and which locks the cover (B) to the body (C) and then releases said cover (B) by means of the rotation motion received from the locking pin (10),
a lock body (40) which forms a border to the lock bolt (70) and allows the required tightening force to be applied to the locking pin (10), which limits the motion of the stop surface (41) and the lock bolt (70) at the rotation axis (W), having the opposite stop surface (42) thereon and on which all of the components of the locking mechanism (A) is positioned,
and a pressure spring (50) which is positioned on the locking pin (10) and creates pressure between the locking pin (10) and he lock bolt (70) and allows that lock bolt (70) to rotate at the same time when the locking pin (10) is rotated.

2. A locking mechanism (A) according to claim 1, characterized in comprising a thrust spring (80) which allows a pressure force to be applied to the cover (B) when the lock bolt (70) that is attached onto the locking pin (10) is at the released position.

3. A locking mechanism (A) according to claim 1, characterized in comprising a gasket (30) located between the locking mechanism (A) and the cover (B) which provides impermeability against any external factors.

4. A locking mechanism (A) according to claim 1, characterized in comprising a cotter pin (90) which fixes the mobile components that form the locking mechanism (A) with the locking pin (10) from the opposite stop surface (42) onto the lock body (40).

5. A locking mechanism (A) according to claim 1, characterized in comprising a gasket (60) which provides impermeability between the mobile components of the locking mechanism (A).

6. A locking mechanism (A) according to claim 1, characterized in that said opposite stop surface (42) is positioned such that it can limit the motion at the rotation axis (W) of the lock bolt (70) to 90°.
